(19) United States
(12) Patent Application Publication
(10) Pub. No.: US 2023/0176205 A1
(43) Pub. Date: Jun. 8, 2023

(54) SURVEILLANCE MONITORING METHOD

(71) Applicant: PRIMAX ELECTRONICS LTD., Taipei City (TW)

(72) Inventors: Cheng-Mu YU, Taipei City (TW); Ming-Je YU, Taipei City (TW); Chih-Wei KE, Taipei City (TW)

(21) Appl. No.: 17/644,607

(22) Filed: Dec. 16, 2021

(30) Foreign Application Priority Data
Dec. 6, 2021 (TW) 110145544

(51) Int. Cl. G01S 13/86; G06T 7/277; G06V 20/52; G06V 10/80; H04N 7/18; G01S 13/66

(52) U.S. Cl. CPC G01S 13/867; G06T 7/277; G06V 20/52; G06V 10/80; H04N 7/18; G01S 13/66; G06T 2207/30232; G06T 2207/20081

(57) ABSTRACT

A surveillance monitoring method is provided, which includes: executing an algorithm using a camera to perform a first inference on recognition of an obstacle and recognition of a target; tracking at least one object using the camera to generate image information; performing a second inference on recognition of the obstacle and recognition of the target using a radar; tracking the at least one object using the radar to generate radar information; fusing the image information and the radar information to obtain a first recognition result; collecting environmental information using the camera or the radar, and forming a confidence level based on the environmental information, the first inference, and the second inference; and dynamically adjusting a proportion of the image information and the radar information according to the confidence level when fusing the image information and the radar information to obtain a second recognition result.

### FIELD OF THE INVENTION

The present invention relates to a surveillance monitoring method, in particular, a surveillance monitoring method that can be applied to surveillance monitoring fields such as virtual fence, perimeter intrusion detection system (PIDS), and home security.

### BACKGROUND OF THE INVENTION

Please refer to FIG. 1. When two different sensing mechanisms of camera and radar are used to track an actual object (range 1) simultaneously, the camera will obtain a tracking result (range 2), and the radar will also obtain a tracking result (range 3). A common method is to fuse the two tracking results (range 4) to confirm existence of the same target, thereby reducing probability of misjudgment.

However, it can be found from FIG. 1 that the range 4 after fusing the tracking result obtained by the camera (the range 2) and the tracking result obtained by the radar (the range 3) is often smaller than the actual range of the object (the range 1), this is caused by different characteristics of the camera and the radar. Take the real-world environment as an example. When the surrounding environment is in dense fog, or wind and rain, the camera from a visual angle is more likely to increase misjudgment or miss detection, which will reduce accuracy of detection. At this time, the actual existing object can only be detected by the radar, so the fusion cannot be performed.

Therefore, the existing monitoring method that uses the camera and the radar to track the object simultaneously still need to be improved.

### SUMMARY OF THE INVENTION

In view of this, the present invention provides a surveillance monitoring method that can improve accuracy of object tracking. When fusing image information and radar information, a parameter of environmental information is added, and a proportion of the image information and the radar information is dynamically adjusted, so that the surveillance monitoring method provided by the present invention can adapt to various weathers.

According to an embodiment of the present invention, a surveillance monitoring method is provided. The surveillance monitoring method includes: executing an algorithm using a camera to perform a first inference on recognition of an obstacle and recognition of a target; tracking at least one object using the camera to generate image information; performing a second inference on recognition of the obstacle and recognition of the target using a radar; tracking the at least one object using the radar to generate radar information; fusing the image information and the radar information to obtain a first recognition result; collecting environmental information using the camera or the radar, and forming a confidence level based on the environmental information, the first inference, and the second inference; and dynamically adjusting a proportion of the image information and the radar information according to the confidence level when fusing the image information and the radar information to obtain a second recognition result.

Preferably, the camera is a PTZ camera.

Preferably, the algorithm is a machine learning algorithm or a deep learning algorithm.

Preferably, the camera or the radar uses an extended Kalman filter (EKF) algorithm to track the object.

Preferably, the radar is a millimeter wave radar.

Preferably, the camera and the radar are integrated in a surveillance monitoring device.

### BRIEF DESCRIPTION OF THE DRAWINGS

FIG. 1 is a schematic diagram representing an actual object, a tracking result of a camera, a tracking result of a radar, and a range of fusing the tracking result of the camera and the tracking result of the radar.

FIG. 2 is a flowchart of a surveillance monitoring method according to an embodiment of the present invention.

FIGS. 3-5 are schematic diagrams of scenes corresponding to the surveillance monitoring method of FIG. 2.

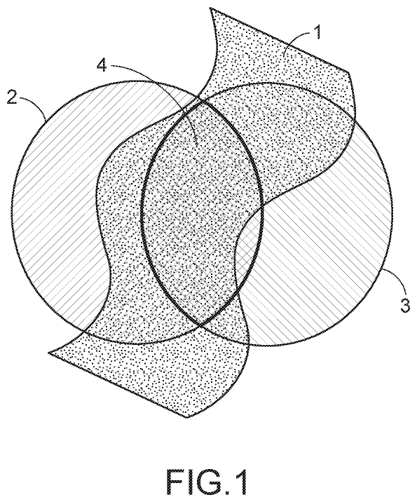

### DETAIL DESCRIPTION OF THE PREFERRED EMBODIMENT

The following provides actual examples to illustrate technical features and technical effects of the present disclosure that can be achieved.

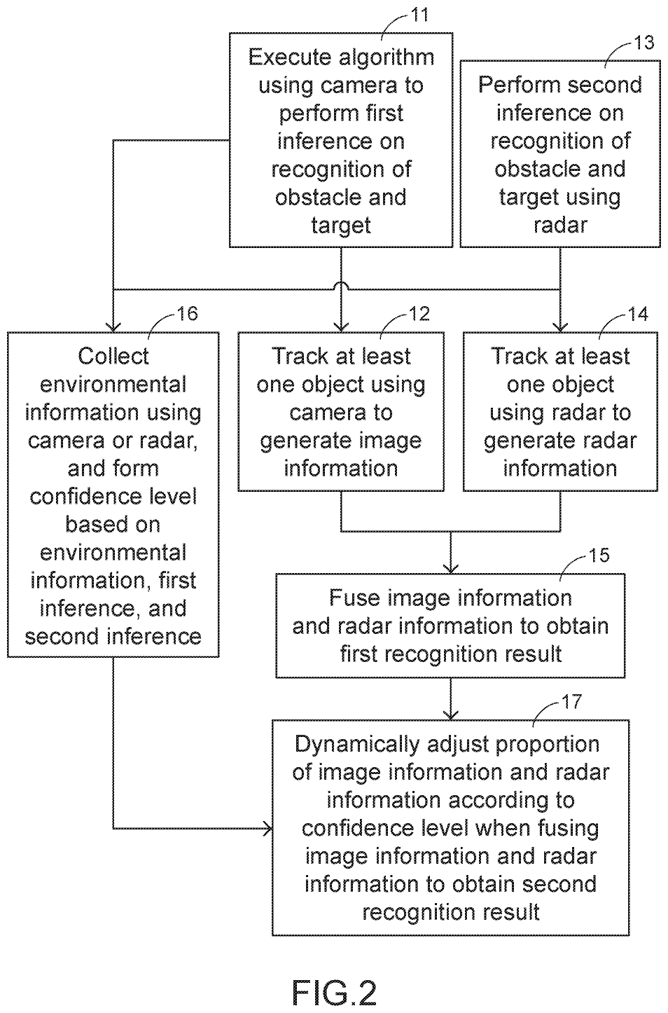

According to an embodiment of the present invention, a surveillance monitoring method is provided. The surveillance monitoring method can be applied to a surveillance monitoring device 5 having both a camera 21 and a radar 31. Please also refer to FIGS. 2-5, the surveillance monitoring method includes following steps.

In Step 11, an algorithm is executed using the camera to perform a first inference on recognition of an obstacle (obstacle inference) and a recognition of a target (object recognition). The algorithm executed in Step 11 can be a machine learning algorithm or a deep learning algorithm.

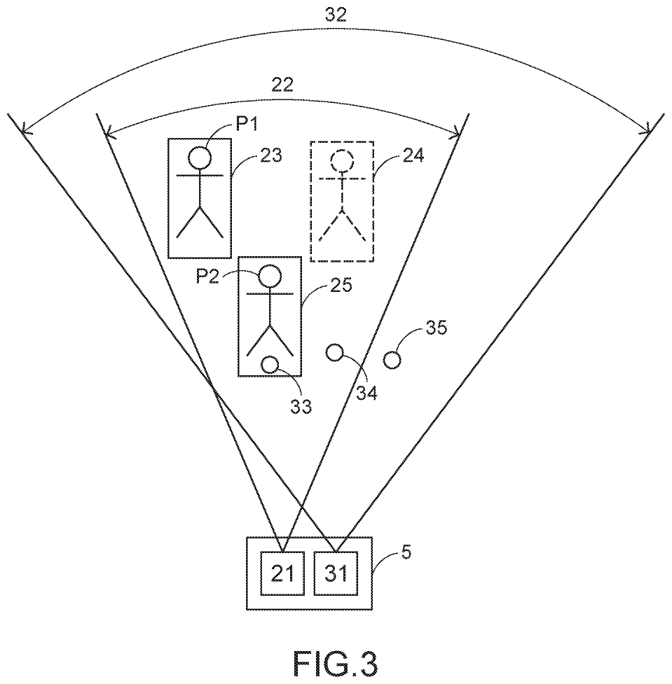

In Step 12, at least one object is tracked using the camera to generate image information. Please refer to a scene shown in FIG. 3. Assuming that there are actually two people P1 and P2 in a sensing range 22 of the camera 21, after Steps 11 and 12 are performed, the camera 21 may generate three image information 23, 24, 25, of which image information 24 is wrong image information.

In Step 13, a second inference is performed on recognition of the obstacle and recognition of the target using the radar. The radar can be a frequency modulated continuous waveform radar (FMCW radar).

In Step 14, the at least one object is tracked using the radar to generate radar information. Please refer to the scene shown in FIG. 3. Assuming that there are actually two people P1 and P2 in a sensing range 32 of the radar 31, after Steps 13 and 14 are performed, the radar 31 may generate three radar information 33, 34 and 35.

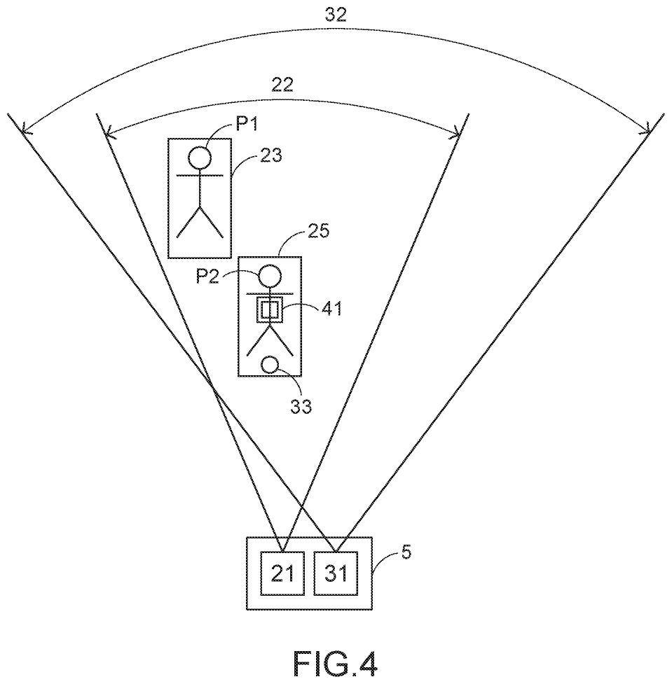

In Step 15, the image information and the radar information are fused to obtain at least one first recognition result. Please refer to FIG. 4. After Step 15 is executed based on the information collected in Steps 11, 12, 13, and 14, two image information 23, 25 and one radar information 33 will be confirmed and tracked, in which the person P2 corresponds to the image information 25 and the radar information 33, so the image information 25 and the radar information 33 can be paired to form fusion information 41, which is marked with a double square, and the person P1 only corresponds to the image information 23 but no radar information, so only the label of the image information is retained and there is no label of fusion information corresponding to the person P1. In this step, the fusion information 41 used to confirm that the person P2 has been tracked, and the image information 23 that cannot be confirmed that the person P1 has been tracked constitute a first recognition result.

In Step 16, environment information that they are located is collected using the camera or the radar, and a confidence level is formed based on the environmental information, the first inference, and the second inference. The way of forming the confidence level in Step 16 can be obtained by executing a machine learning algorithm or a deep learning algorithm.

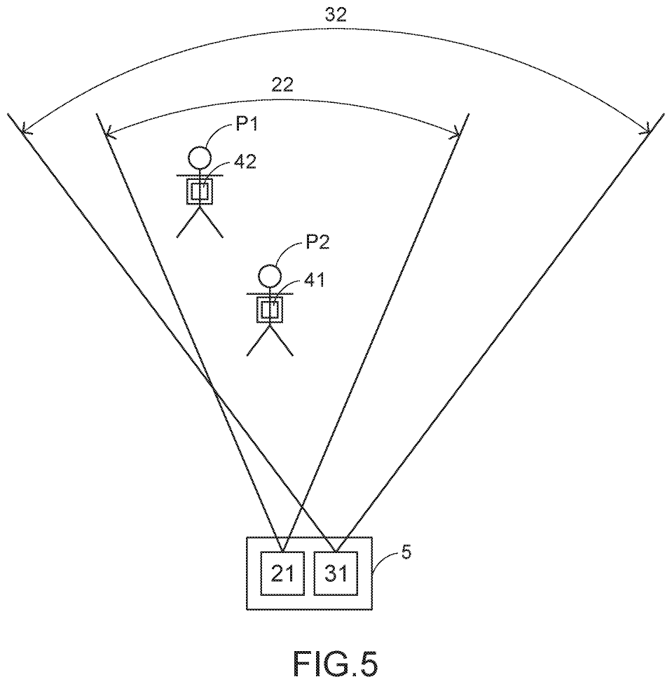

In Step 17, a proportion of the image information and the radar information is adjusted according to the confidence level when fusing the image information and the radar information to obtain a second recognition result. Please refer to FIGS. 4 and 5 simultaneously. In the first recognition result generated in the above Step 15, the person P1 only corresponds to the image information 23 and does not have fusion information. Step 16 is to obtain the environmental information and evaluate the confidence level of the image information 23 through the machine learning algorithm or the deep learning algorithm. Please refer to FIG. 5. Assuming that the surveillance monitoring device is in a weather that the radar is easily affected, and the confidence level of the image information evaluated in Step 16 is higher than a system preset confidence level, it means that the image information 23 reaches the level, so it can choose to adopt (or trust) the camera's tracking results more and increase the proportion of the camera's tracking results when fusion. In this way, in Step 17, the image information 23 corresponding to the person P1 can be upgraded to form fusion information 42, which is marked with a double square. At this time, the fusion information 42 used to confirm that the person P1 has been tracked and the fusion information 41 used to confirm that the person P2 has been tracked constitute a second recognition result.

Comparing the first recognition result generated in Step 15 shown in FIG. 4 and the second recognition result generated in Step 17 shown in FIG. 5, it can be found that in the present disclosure, after the parameter of the environmental information is added and the proportion (or the confidence level) of the image information is adjusted, the object (the person P1) that was originally only detected by the camera can also be confirmed and tracked. In the same way, in other embodiments according to the present invention, it is also possible to adopt (or trust) the radar's tracking results more and adjust the proportion (or the confidence level) of the radar information after the parameter of the environmental information is added, so that the object that was originally only detected by the radar can also be confirmed and tracked.

In the foregoing embodiment, the environmental information may be a weather condition, such as rain, fog, sand, strong light interference, obstacles, day or night, etc. A mechanism used to detect the weather condition can be the camera or the radar itself, or in other embodiments it is achieved by an additional sensing device.

In the surveillance monitoring method provided in this embodiment, the program of Step 11 can be executed before Step 12 is executed, but it is not necessary to execute the program of Step 11 before Step 12 is executed each time. Furthermore, in the surveillance monitoring method provided in this embodiment, the program of Step 13 can be executed before Step 14 is executed, but it is not necessary to execute the procedure of Step 13 before Step 14 is executed each time.

In the surveillance monitoring method provided in this embodiment, before Step 15 is executed, the program of Step 12 and the program of Step 14 will be executed first, and Step 12 and Step 14 can be executed simultaneously or sequentially.

The method of adjusting information fusion according to the environmental information of the surveillance monitoring device 5 adopted in this embodiment can achieve more accurate judgment and detection, and also reduce possibility of false alarms.

The surveillance monitoring method provided in this embodiment can be applied to the surveillance monitoring device 5. The surveillance monitoring device 5 integrates the camera 21 and the radar 31 therein, and directly executes the step of fusing the radar information and the image information. In addition, the surveillance monitoring device 5 does not need to send the radar information and the image information to an external device or a third-party device for fusion calculation, so cost and complexity of system installation can be reduced.

When the surveillance monitoring method provided in this embodiment is applied to the surveillance monitoring device 5, the camera 21 can be a pan tilt zoom (PTZ) camera, which can simultaneously meet requirements of wide-angle and long-distance detection. In addition, in this embodiment, the radar information generated by the radar 31 can be used to further adjust a posture of the PTZ camera.

In the surveillance monitoring method provided in this embodiment, the camera 21 can use an extended Kalman filter (EKF) algorithm to track the object(s), and the radar 31 can also use the extended Kalman filter algorithm to track the object(s).

When the surveillance monitoring method provided in this embodiment is applied to the surveillance monitoring device 5, the radar 31 may be a millimeter-wave radar, which has better penetration of raindrops, fog, sand or dust, and is not disturbed by strong ambient light, so orientation of the object(s) can be detected more accurately.

When the surveillance monitoring method provided in this embodiment is applied to the surveillance monitoring device 5, it can also be adapted to needs of various detection distances by replacing the radar(s) with different detection distances and different frequency bands, and it also meets regulatory requirements of different countries.

The foregoing descriptions are only preferred embodiments of the present invention and are not intended to limit the present invention. Therefore, all other equivalent changes or modifications without departing from the spirit of the present invention should be included in the present invention.

What is claimed is:

1. A surveillance monitoring method, comprising:
executing an algorithm using a camera to perform a first inference on recognition of an obstacle and recognition of a target;
tracking at least one object using the camera to generate image information;
performing a second inference on recognition of the obstacle and recognition of the target using a radar;
tracking the at least one object using the radar to generate radar information;
fusing the image information and the radar information to obtain a first recognition result;
collecting environmental information using the camera or the radar, and forming a confidence level based on the environmental information, the first inference, and the second inference; and
dynamically adjusting a proportion of the image information and the radar information according to the confidence level when fusing the image information and the radar information to obtain a second recognition result.

2. The surveillance monitoring method of claim 1, wherein the camera is a PTZ camera.

3. The surveillance monitoring method of claim 1, wherein the algorithm is a machine learning algorithm or a deep learning algorithm.

4. The surveillance monitoring method of claim 1, wherein the camera or the radar uses an extended Kalman filter (EKF) algorithm to track the object.

5. The surveillance monitoring method of claim 1, wherein the radar is a millimeter wave radar.

6. The surveillance monitoring method of claim 1, wherein the camera and the radar are integrated in a surveillance monitoring device.
